(19) United States
(12) Patent Application Publication
(10) Pub. No.: US 2024/0371177 A1
(43) Pub. Date: Nov. 7, 2024

(54) DETERMINING RELEVANCE OF TRAFFIC SIGNS

(71) Applicant: GM Global Technology Operations LLC, Detroit, MI (US)

(72) Inventors: Darren Michael Chan, Thousand Oaks, CA (US); Jiejun Xu, Diamond Bar, CA (US); Alireza Esna Ashari Esfahani, Novi, MI (US)

(21) Appl. No.: 18/311,294

(22) Filed: May 3, 2023

(51) Int. Cl. G06V 20/58; G01S 19/42; G06T 7/12; G06T 7/70; G06V 10/20; G06V 10/25

(52) U.S. Cl. CPC G06V 20/582; G01S 19/42; G06T 7/12; G06T 7/70; G06V 10/25; G06V 10/255

(57) ABSTRACT

A system for determining a relevance of a traffic sign for a vehicle includes at least one vehicle camera configured to provide a view of an environment surrounding the vehicle and a vehicle controller in electrical communication with the at least one vehicle camera. The vehicle controller is programmed to capture an image using the at least one vehicle camera. The vehicle controller is further programmed to identify the traffic sign in the image. The vehicle controller is further programmed to determine a pan angle and a tilt angle of the traffic sign based at least in part on the image. The vehicle controller is further programmed to determine the relevance of the traffic sign based at least in part on the pan angle and the tilt angle of the traffic sign.

### INTRODUCTION

The present disclosure relates to advanced driver assistance and automated driving systems and methods for vehicles, and more particularly, to computer vision systems and methods for vehicles.

To increase occupant awareness and convenience, vehicles may be equipped with advanced driver assistance systems (ADAS) and/or automated driving systems (ADS). ADAS systems may use various sensors such as cameras, radar, and LiDAR to detect and identify objects around the vehicle, including other vehicles, pedestrians, road configurations, and traffic signs. ADAS systems may take actions based on environmental conditions surrounding the vehicle, such as applying brakes or alerting an occupant of the vehicle. However, current navigation systems may not account for additional factors which may affect occupant experience. ADS systems may use various sensors to detect objects in the environment around the vehicle and control the vehicle to navigate the vehicle through the environment to a predetermined destination. However, current ADAS and ADS systems may rely on correct interpretation of traffic signs in order to function optimally. Characteristics of traffic signs, including placements, height, orientation, and the like may vary widely. Accordingly, current ADAS and ADS systems may not correctly interpret traffic signs in all situations.

Thus, while ADAS and ADS systems and methods achieve their intended purpose, there is a need for a new and improved system and method for determining a relevance of a traffic sign for a vehicle.

### SUMMARY

According to several aspects, a system for determining a relevance of a traffic sign for a vehicle is provided. The system includes at least one vehicle camera configured to provide a view of an environment surrounding the vehicle and a vehicle controller in electrical communication with the at least one vehicle camera. The vehicle controller is programmed to capture an image using the at least one vehicle camera. The vehicle controller is further programmed to identify the traffic sign in the image. The vehicle controller is further programmed to determine a pan angle and a tilt angle of the traffic sign based at least in part on the image. The vehicle controller is further programmed to determine the relevance of the traffic sign based at least in part on the pan angle and the tilt angle of the traffic sign.

In another aspect of the present disclosure, to identify the traffic sign in the image, the vehicle controller is further programmed to identify an object in the image. To identify the traffic sign in the image, the vehicle controller is further programmed to identify a plurality of edges of the object based at least in part on the image. To identify the traffic sign in the image, the vehicle controller is further programmed to determine the object to be the traffic sign based at least in part on the plurality of edges of the object.

In another aspect of the present disclosure, to identify the object in the image, the vehicle controller is further programmed to extract a region of interest of the image using a deep learning model. The region of interest includes the object. To identify the object in the image, the vehicle controller is further programmed to generate a first segmentation mask of the region of interest. The first segmentation mask includes a portion of the region of interest having the object.

In another aspect of the present disclosure, to identify the plurality of edges of the object, the vehicle controller is further programmed to determine four points which correspond to four corners of the first segmentation mask. To identify the plurality of edges of the object, the vehicle controller is further programmed to identify the plurality of edges of the object. A first terminus and a second terminus of each of the plurality of edges is one of the four points. The plurality of edges form a closed polygon. To identify the plurality of edges of the object, the vehicle controller is further programmed to generate a second segmentation mask. The second segmentation mask is an area enclosed by the plurality of edges.

In another aspect of the present disclosure, to determine the object to be the traffic sign, the vehicle controller is further programmed to determine a normalized fitness score of the second segmentation mask with respect to the first segmentation mask. To determine the object to be the traffic sign, the vehicle controller is further programmed to compare the normalized fitness score to a predetermined normalized fitness score threshold. To determine the object to be the traffic sign, the vehicle controller is further programmed to determine the object to be the traffic sign in response to determining that the normalized fitness score is greater than or equal to the predetermined normalized fitness score threshold.

In another aspect of the present disclosure, to determine the normalized fitness score, the vehicle controller is further programmed to determine an intersection area between the first segmentation mask and the second segmentation mask. To determine the normalized fitness score, the vehicle controller is further programmed to determine a union area between the first segmentation mask and the second segmentation mask. To determine the normalized fitness score, the vehicle controller is further programmed to determine the normalized fitness score. The normalized fitness score is equal to the intersection area divided by the union area.

In another aspect of the present disclosure, to determine the pan angle and the tilt angle of the traffic sign, the vehicle controller is further programmed to identify a first vanishing point of the traffic sign based at least in part on the plurality of edges. To determine the pan angle and the tilt angle of the traffic sign, the vehicle controller is further programmed to identify a second vanishing point of the traffic sign based at least in part on the plurality of edges. To determine the pan angle and the tilt angle of the traffic sign, the vehicle controller is further programmed to determine the pan angle and the tilt angle of the traffic sign based at least in part on the first vanishing point and the second vanishing point.

In another aspect of the present disclosure, to determine the relevance of the traffic sign, the vehicle controller is further programmed to compare the pan angle of the traffic sign to a predetermined pan angle threshold. To determine the relevance of the traffic sign, the vehicle controller is further programmed to compare the tilt angle of the traffic sign to a predetermined tilt angle threshold. To determine the relevance of the traffic sign, the vehicle controller is further programmed to determine the relevance of the traffic sign to be irrelevant in response to determining that at least one of the pan angle of the traffic sign is greater than or equal to the predetermined pan angle threshold and the tilt angle of the traffic sign is greater than or equal to the predetermined tilt angle threshold. To determine the relevance of the traffic sign, the vehicle controller is further programmed to determine the relevance of the traffic sign to be relevant in response to determining that the pan angle of the traffic sign is less than the predetermined pan angle threshold and the tilt angle of the traffic sign is less than the predetermined tilt angle threshold.

In another aspect of the present disclosure, the system further includes a global navigation satellite system (GNSS) in electrical communication with the vehicle controller. The vehicle controller is further programmed to determine a location of the vehicle using the GNSS. The vehicle controller is further programmed to determine a location of the traffic sign based at least in part on the location of the vehicle. The vehicle controller is further programmed to save the relevance of the traffic sign and the location of the traffic sign in a non-transitory memory of the vehicle controller in response to determining that the traffic sign is relevant.

In another aspect of the present disclosure, the system further includes a vehicle communication system in electrical communication with the vehicle controller. The vehicle controller is further programmed to transmit the relevance of the traffic sign and the location of the traffic sign to a remote server system using the vehicle communication system.

According to several aspects, a method for determining a relevance of a traffic sign for a vehicle is provided. The method includes capturing an image using at least one vehicle camera. The method also includes identifying the traffic sign in the image. The method also includes determining a pan angle and a tilt angle of the traffic sign based at least in part on the image. The method also includes determining the relevance of the traffic sign based at least in part on the pan angle and the tilt angle of the traffic sign.

In another aspect of the present disclosure, identifying the traffic sign in the image further may include identifying an object in the image. Identifying the traffic sign in the image further may include identifying a plurality of edges of the object based at least in part on the image. Identifying the traffic sign in the image further may include determining the object to be the traffic sign based at least in part on the plurality of edges of the object.

In another aspect of the present disclosure, identifying the object in the image further may include extracting a region of interest of the image using a deep learning model. The region of interest includes the object. Identifying the object in the image further may include generating a first segmentation mask of the region of interest. The first segmentation mask includes a portion of the region of interest having the object.

In another aspect of the present disclosure, identifying the plurality of edges of the object further may include determining four points which correspond to four corners of the first segmentation mask. Identifying the plurality of edges of the object further may include identifying the plurality of edges of the object. A first terminus and a second terminus of each of the plurality of edges is one of the four points. The plurality of edges form a closed polygon. Identifying the plurality of edges of the object further may include generating a second segmentation mask. The second segmentation mask is an area enclosed by the plurality of edges.

In another aspect of the present disclosure, determining the object to be the traffic sign further may include determining an intersection area between the first segmentation mask and the second segmentation mask. Determining the object to be the traffic sign further may include determining a union area between the first segmentation mask and the second segmentation mask. Determining the object to be the traffic sign further may include determining a normalized fitness score. The normalized fitness score is equal to the intersection area divided by the union area. Determining the object to be the traffic sign further may include comparing the normalized fitness score to a predetermined normalized fitness score threshold. Determining the object to be the traffic sign further may include determining the object to be the traffic sign in response to determining that the normalized fitness score is greater than or equal to the predetermined normalized fitness score threshold.

In another aspect of the present disclosure, determining the pan angle and the tilt angle of the traffic sign further may include identifying a first vanishing point of the traffic sign based at least in part on the plurality of edges. Determining the pan angle and the tilt angle of the traffic sign further may include identifying a second vanishing point of the traffic sign based at least in part on the plurality of edges. Determining the pan angle and the tilt angle of the traffic sign further may include determining the pan angle and the tilt angle of the traffic sign based at least in part on the first vanishing point and the second vanishing point.

In another aspect of the present disclosure, determining the relevance of the traffic sign further comprises comparing the pan angle of the traffic sign to a predetermined pan angle threshold. Determining the relevance of the traffic sign further comprises comparing the tilt angle of the traffic sign to a predetermined tilt angle threshold. Determining the relevance of the traffic sign further comprises determining the relevance of the traffic sign to be irrelevant in response to determining that at least one of the pan angle of the traffic sign is greater than or equal to the predetermined pan angle threshold and the tilt angle of the traffic sign is greater than or equal to the predetermined tilt angle threshold. Determining the relevance of the traffic sign further comprises determining the relevance of the traffic sign to be relevant in response to determining that the pan angle of the traffic sign is less than the predetermined pan angle threshold and the tilt angle of the traffic sign is less than the predetermined tilt angle threshold.

According to several aspects, a system for determining a relevance of a traffic sign for a vehicle is provided. The system includes at least one vehicle camera configured to provide a view of an environment surrounding the vehicle and a vehicle controller in electrical communication with the at least one vehicle camera. The vehicle controller is programmed to capture an image using the at least one vehicle camera. The vehicle controller is further programmed to extract a region of interest of the image using a deep learning model. The region of interest includes an object. The vehicle controller is further programmed to generate a first segmentation mask of the region of interest. The first segmentation mask describes a portion of the region of interest including only the object. The vehicle controller is further programmed to determine four points which correspond to four corners of the first segmentation mask. The vehicle controller is further programmed to identify a plurality of edges of the object. A first terminus and a second terminus of each of the plurality of edges is one of the four points. The plurality of edges form a closed polygon. The vehicle controller is further programmed to generate a second segmentation mask. The second segmentation mask is an area enclosed by the plurality of edges. The vehicle controller is further programmed to determine the object to be the traffic sign based at least in part on the plurality of edges of the object. The vehicle controller is further programmed to determine a pan angle and a tilt angle of the traffic sign based at least in part on the image. The vehicle controller is further programmed to compare the pan angle of the traffic sign to a predetermined pan angle threshold. The vehicle controller is further programmed to compare the tilt angle of the traffic sign to a predetermined tilt angle threshold. The vehicle controller is further programmed to determine the relevance of the traffic sign to be irrelevant in response to determining that at least one of: the pan angle of the traffic sign is greater than or equal to the predetermined pan angle threshold and the tilt angle of the traffic sign is greater than or equal to the predetermined tilt angle threshold. The vehicle controller is further programmed to determine the relevance of the traffic sign to be relevant in response to determining that the pan angle of the traffic sign is less than the predetermined pan angle threshold and the tilt angle of the traffic sign is less than the predetermined tilt angle threshold.

In another aspect of the present disclosure, to determine the object to be the traffic sign, the vehicle controller is further programmed to determine an intersection area between the first segmentation mask and the second segmentation mask. To determine the object to be the traffic sign, the vehicle controller is further programmed to determine a union area between the first segmentation mask and the second segmentation mask. To determine the object to be the traffic sign, the vehicle controller is further programmed to determine a normalized fitness score. The normalized fitness score is equal to the intersection area divided by the union area. To determine the object to be the traffic sign, the vehicle controller is further programmed to compare the normalized fitness score to a predetermined normalized fitness score threshold. To determine the object to be the traffic sign, the vehicle controller is further programmed to determine the object to be the traffic sign in response to determining that the normalized fitness score is greater than or equal to the predetermined normalized fitness score threshold.

In another aspect of the present disclosure, to determine the pan angle and the tilt angle of the traffic sign, the vehicle controller is further programmed to identify a first vanishing point of the traffic sign based at least in part on the plurality of edges. To determine the pan angle and the tilt angle of the traffic sign, the vehicle controller is further programmed to identify a second vanishing point of the traffic sign based at least in part on the plurality of edges. To determine the pan angle and the tilt angle of the traffic sign, the vehicle controller is further programmed to determine the pan angle and the tilt angle of the traffic sign based at least in part on the first vanishing point and the second vanishing point.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for determining a relevance of a traffic sign for a vehicle, according to an exemplary embodiment;

FIG. 2 is a top-down schematic diagram of a vehicle and an exemplary traffic sign, according to an exemplary embodiment;

FIG. 3 is a flowchart of a method for determining a relevance of a traffic sign for a vehicle, according to an exemplary embodiment;

FIG. 4A is a schematic diagram of a traffic sign with a first segmentation mask, according to an exemplary embodiment;

FIG. 4B is a schematic diagram of a traffic sign with a second segmentation mask, according to an exemplary embodiment;

FIG. 4C is a schematic diagram of an intersection area between the first segmentation mask and the second segmentation mask, according to an exemplary embodiment;

FIG. 4D is a schematic diagram of a union area between the first segmentation mask and the second segmentation mask, according to an exemplary embodiment;

FIG. 5 is a flowchart of a method to determine a pan angle and a tilt angle of a traffic sign, according to an exemplary embodiment; and

FIG. 6 is a flowchart of a method to transmit a relevance of a traffic sign to a remote server system, according to an exemplary embodiment.

### DETAILED DESCRIPTION

The following description is merely exemplary in nature and is not intended to limit the present disclosure, application, or uses.

Traffic signs may be oriented in a manner such as to indicate their relevance to drivers and vehicles on the roadway. For example, a traffic sign oriented directly at a vehicle may indicate relevance to that vehicle, whereas a traffic sign oriented orthogonally to a vehicle may indicate irrelevance to that vehicle. Thus, traffic sign orientation is important for determining traffic sign relevance. However, determining orientation of traffic signs in varying environmental conditions may currently require sensor systems such as LiDAR, radar, and/or the like, which may increase complexity and resource use. Therefore, the present disclosure provides a new and improved system and method for determining a relevance of a traffic sign for a vehicle.

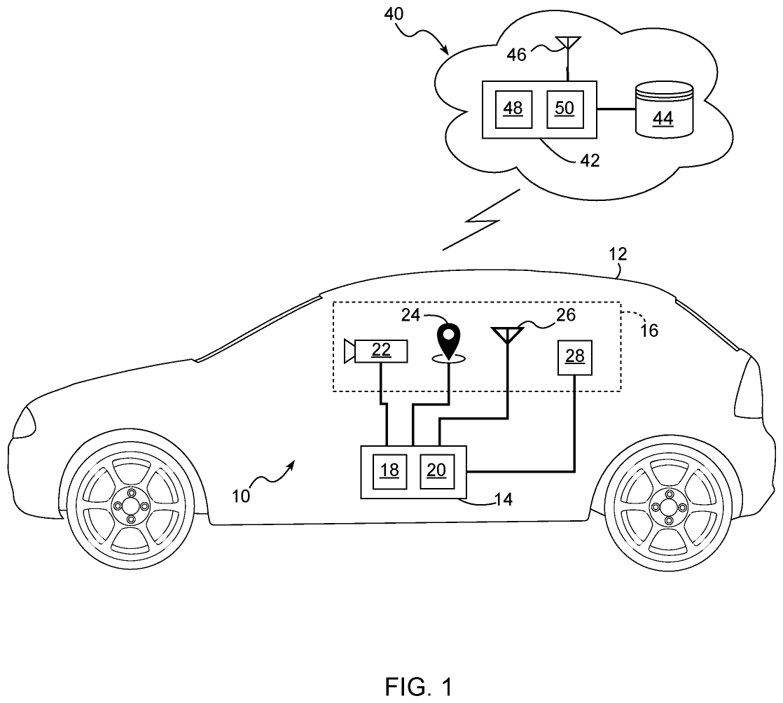

Referring to FIG. 1, a system for determining a relevance of a traffic sign for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a vehicle controller 14 and at least one vehicle sensor 16.

The vehicle controller 14 is used to implement a method 100 for determining a relevance of a traffic sign for a vehicle, as will be described below. The vehicle controller 14 includes at least one processor 18 and a non-transitory computer readable storage device or media 20. The processor 18 may be a custom made or commercially available processor, a central processing unit (CPU), a graphics processing unit (GPU), an auxiliary processor among several processors associated with the vehicle controller 14, a semiconductor-based microprocessor (in the form of a microchip or chip set), a macroprocessor, a combination thereof, or generally a device for executing instructions. The computer readable storage device or media 20 may include volatile and nonvolatile storage in read-only memory (ROM), random-access memory (RAM), and keep-alive memory (KAM), for example. KAM is a persistent or non-volatile memory that may be used to store various operating variables while the processor 18 is powered down. The computer-readable storage device or media 20 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 14 to control various systems of the vehicle 12. The vehicle controller 14 may also consist of multiple controllers which are in electrical communication with each other. The vehicle controller 14 may be inter-connected with additional systems and/or controllers of the vehicle 12, allowing the vehicle controller 14 to access data such as, for example, speed, acceleration, braking, and steering angle of the vehicle 12.

The vehicle controller 14 is in electrical communication with the at least one vehicle sensor 16. In an exemplary embodiment, the electrical communication is established using, for example, a CAN network, a FLEXRAY network, a local area network (e.g., WiFi, ethernet, and the like), a serial peripheral interface (SPI) network, an inter-integrated circuit (I2C) network, or the like. It should be understood that various additional wired and wireless techniques and communication protocols for communicating with the vehicle controller 14 are within the scope of the present disclosure.

The at least one vehicle sensor 16 is used to determine information about an environment surrounding the vehicle 12. In an exemplary embodiment, the at least one vehicle sensor 16 includes a vehicle camera 22, a global navigation satellite system (GNSS) 24, a vehicle communication system 26, and a plurality of additional vehicle sensors 28. The at least one vehicle sensor 16 is in electrical communication with the vehicle controller 14 as discussed above.

The vehicle camera 22 is used to capture images and/or videos of an environment surrounding the vehicle 12. In an exemplary embodiment, the vehicle camera 22 is a photo and/or video camera which is positioned to view the environment in front of the vehicle 12. In one example, the vehicle camera 22 is affixed inside of the vehicle 12, for example, in a headliner of the vehicle 12, having a view through a windscreen of the vehicle 12. In another example, the vehicle camera 22 is affixed outside of the vehicle 12, for example, on a roof of the vehicle 12, having a view of the environment in front of the vehicle 12. It should be understood that surround view camera systems having additional cameras and/or additional mounting locations are within the scope of the present disclosure. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure. The vehicle camera 22 is in electrical communication with the vehicle controller 14 as discussed above.

The GNSS 24 is used to determine a geographical location of the vehicle 12. In an exemplary embodiment, the GNSS 24 is a global positioning system (GPS). In a non-limiting example, the GPS includes a GPS receiver antenna (not shown) and a GPS controller (not shown) in electrical communication with the GPS receiver antenna. The GPS receiver antenna receives signals from a plurality of satellites, and the GPS controller calculates the geographical location of the vehicle 12 based on the signals received by the GPS receiver antenna. In an exemplary embodiment, the GNSS 24 additionally includes a map. The map includes information about infrastructure such as municipality borders, roadways, railways, sidewalks, buildings, and the like. Therefore, the geographical location of the vehicle 12 is contextualized using the map information. In a non-limiting example, the map is retrieved from a remote source using a wireless connection. In another non-limiting example, the map is stored in a database of the GNSS 24. It should be understood that various additional types of satellite-based radionavigation systems, such as, for example, the Global Positioning System (GPS), Galileo, GLONASS, and the BeiDou Navigation Satellite System (BDS) are within the scope of the present disclosure. It should be understood that the GNSS 24 may be integrated with the vehicle controller 14 (e.g., on a same circuit board with the vehicle controller 14 or otherwise a part of the vehicle controller 14) without departing from the scope of the present disclosure. The GNSS 24 is in electrical communication with the vehicle controller 14 as discussed above.

The vehicle communication system 26 is used by the vehicle controller 14 to communicate with other systems external to the vehicle 12. For example, the vehicle communication system 26 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems). In certain embodiments, the vehicle communication system 26 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 26 may further include an embedded universal integrated circuit card (eUICC) configured to store at least one cellular connectivity configuration profile, for example, an embedded subscriber identity module (eSIM) profile. The vehicle communication system 26 is further configured to communicate via a personal area network (e.g., BLUETOOTH) and/or near-field communication (NFC). However, additional or alternate communication methods, such as a dedicated short-range communications (DSRC) channel and/or mobile telecommunications protocols based on the 3^{rd} Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure. Accordingly, the vehicle communication system 26 may include one or more antennas and/or communication transceivers for receiving and/or transmitting signals, such as cooperative sensing messages (CSMs). The vehicle communication system 26 is configured to wirelessly communicate information between the vehicle 12 and another vehicle. Further, the vehicle communication system 26 is configured to wirelessly communicate information between the vehicle 12 and infrastructure or other vehicles. It should be understood that the vehicle communication system 26 may be integrated with the vehicle controller 14 (e.g., on a same circuit board with the vehicle controller 14 or otherwise a part of the vehicle controller 14) without departing from the scope of the present disclosure. The vehicle communication system 26 is in electrical communication with the vehicle controller 14 as discussed above.

The plurality of additional vehicle sensors 28 is used to determine performance data about the vehicle 12. In an exemplary embodiment, the plurality of additional vehicle sensors 28 includes at least one of a motor speed sensor, a motor torque sensor, an electric drive motor voltage and/or current sensor, an accelerator pedal position sensor, a brake pedal position sensor, a steering angle sensor, a seat occupancy sensor, a coolant temperature sensor, a cooling fan speed sensor, and a transmission oil temperature sensor. In another exemplary embodiment, the plurality of vehicle sensors further includes sensors to determine information about an environment surrounding the vehicle 12, for example, an ambient air temperature sensor, and/or a barometric pressure sensor. The plurality of additional vehicle sensors 28 is in electrical communication with the vehicle controller 14 as discussed above.

With continued reference to FIG. 1, a remote server system is illustrated and generally indicated by reference number 40. The remote server system 40 includes a server controller 42 in electrical communication with a server database 44 and a server communication system 46. In a non-limiting example, the remote server system 40 is located in a server farm, datacenter, or the like, and connected to the internet. The server controller 42 includes at least one server processor 48 and a server non-transitory computer readable storage device or server media 50. The description of the type and configuration given above for the vehicle controller 14 also applies to the server controller 42. In a non-limiting example, the server processor 48 and server media 50 of the server controller 42 are similar in structure and/or function to the processor 18 and the media 20 of the vehicle controller 14, as described above. The server communication system 46 is used to communicate with external systems, such as, for example, the vehicle controller 14 via the vehicle communication system 26. In a non-limiting example, server communication system 46 is similar in structure and/or function to the vehicle communication system 26 of the system 10, as described above.

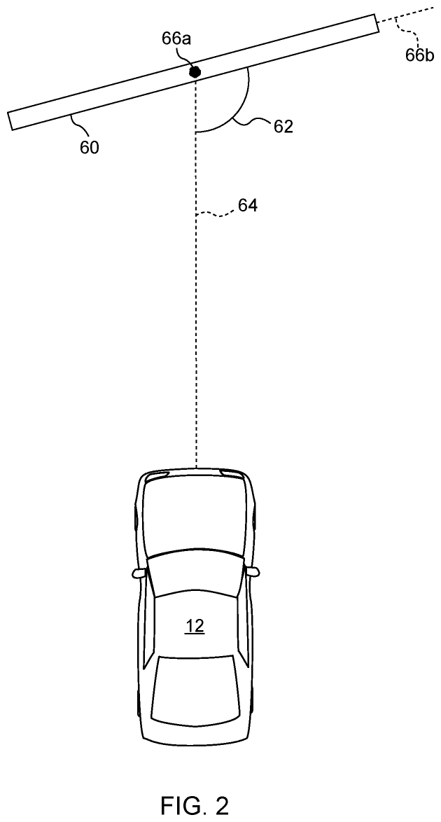

Referring to FIG. 2, a top-down schematic diagram of the vehicle 12 and an exemplary traffic sign 60 is shown. An orientation of the traffic sign 60 relative to the vehicle 12 is described by a pan angle 62 and a tilt angle (not shown). In the scope of the present disclosure, the pan angle 62 is an angle of the traffic sign 60 relative to the direction of travel 64 of the vehicle 12 and measures a rotation of the traffic sign 60 around a vertical axis 66a. The tilt angle is an angle of the traffic sign 60 relative to a predetermined plane and measures a rotation of the traffic sign 60 around a horizontal axis 66b. In a non-limiting example, the predetermined plane may be defined by a line-of-sight of an occupant of the vehicle 12. In another non-limiting example, the predetermined plane may be at a location of a road surface.

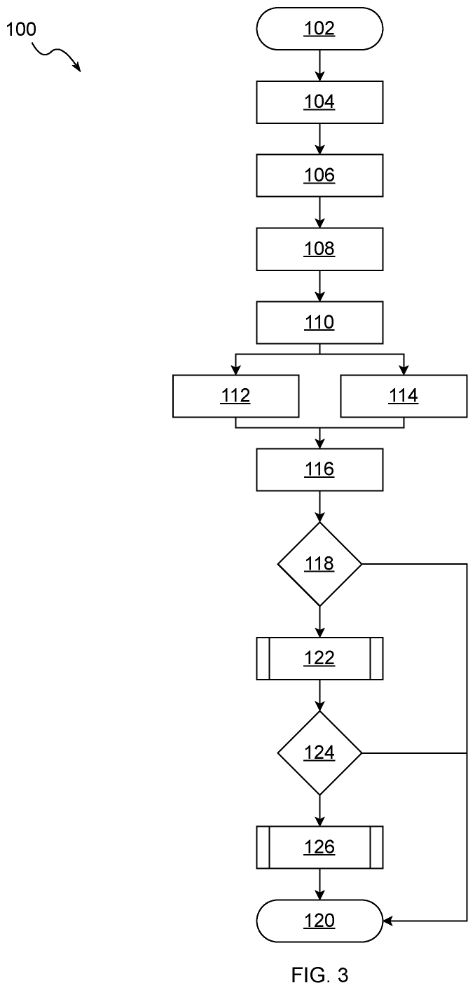

Referring to FIG. 3, a flowchart of the method 100 for determining a relevance of a traffic sign for a vehicle is shown. The method 100 begins at block 102 and proceeds to block 104. At block 104, the vehicle controller 14 uses the vehicle camera 22 to capture an image. In an exemplary embodiment, the image includes a view of the environment in front of the vehicle 12. After block 104, the method 100 proceeds to block 106.

At block 106, the vehicle controller 14 extracts a region of interest containing the traffic sign 60 from the image captured at block 104. In an exemplary embodiment, the vehicle controller 14 uses a deep learning model, for example, a convolutional neural network (CNN), to identify the region of interest. In a non-limiting example, the CNN includes multiple layers of neurons which perform convolution operations on the image. The first layer of neurons applies a set of filters (also known as kernels) to the input data to detect simple features, such as edges or corners. Subsequent layers apply more complex filters to detect higher-level features, such as shapes or patterns. The outputs from each layer are passed on to the next layer for further processing. In a non-limiting example, the CNN is trained using a large dataset of labeled images of traffic signs. During training, the CNN adjusts weights of neurons to improve accuracy in extracting regions of interest containing traffic signs from images. It should be understood that additional methods in the field of computer vision may be used to extract the region of interest without departing from the scope of the present disclosure.

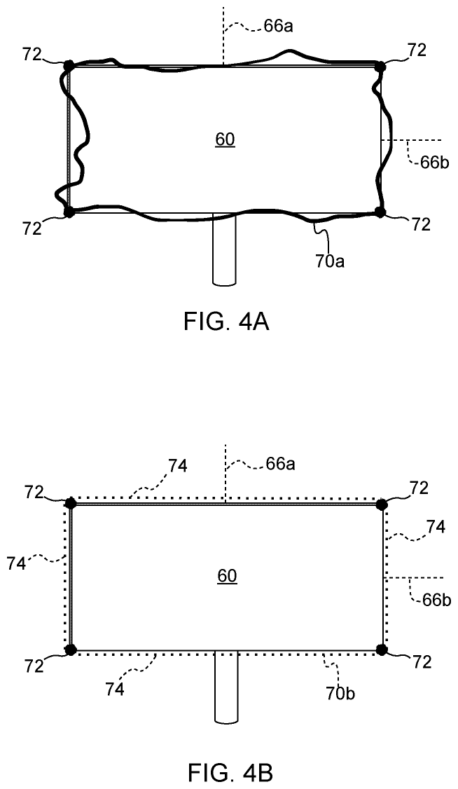

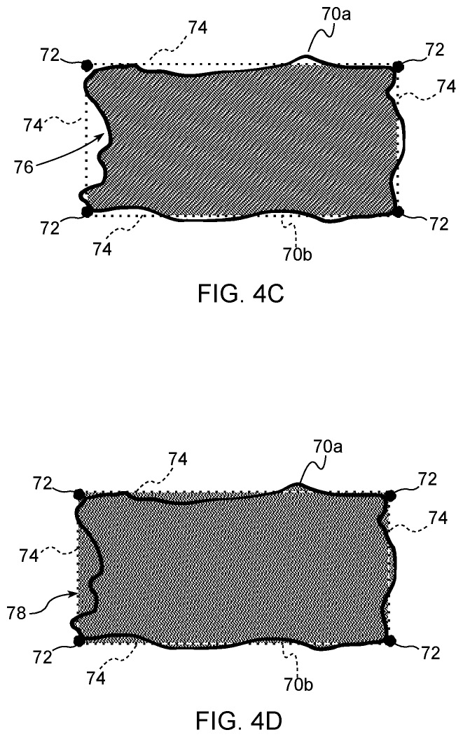

Referring to FIG. 4A, a schematic diagram of the traffic sign 60 with a first segmentation mask 70a is shown. With reference to FIG. 4A and continued reference to FIG. 3, at block 106, after extracting the region of interest, the vehicle controller 14 generates the first segmentation mask 70a. In the scope of the present disclosure, the first segmentation mask 70a is an area of the image captured at block 104 which defines a pixel-level location of the traffic sign 60 in the image. In an exemplary embodiment, the first segmentation mask 70a is determined using a CNN trained to segment traffic signs from the area of interest. As shown in FIG. 4A in an exaggerated manner for clarity, the first segmentation mask 70a may include error introduced by image quality, lighting conditions, weather conditions, and the like, as will be discussed in greater detail below. It should be understood that additional methods of segmentation in the field of computer vision may be used to generate the first segmentation mask 70a without departing from the scope of the present disclosure. Referring again to FIG. 3, after block 106, the method 100 proceeds to block 108.

Referring again to FIG. 4A, with continued reference to FIG. 3, at block 108, the vehicle controller 14 determines a plurality of points 72 which correspond to a plurality of corners of the first segmentation mask 70a. In an exemplary embodiment, the controller 14 determines four points 72 which correspond to four corners of the first segmentation mask 70a. In non-limiting example, each of the four points 72 are determined to be at one of four extreme corners of the first segmentation mask 70a. For example, one of the four points 72 is determined to be at an extreme bottom right corner of the first segmentation mask 70a. In other words, assuming a standard two-dimensional cartesian coordinate system, the one of the four points 72 at the extreme bottom right corner of the first segmentation mask 70a is located at a point on the first segmentation mask 70a simultaneously having a maximum x-coordinate and a minimum y-coordinate. In an exemplary embodiment, the four points 72 are determined using an iterative algorithm based on point coordinates of the first segmentation mask 70a, as described above. In another exemplary embodiment, the four points 72 are determined using a machine learning algorithm (e.g., an CNN) which has been trained to identify corners of segmentation masks. It should be understood that various additional methods for determining the corner points 72 of the first segmentation mask 72a are within the scope of the present disclosure. After block 108, the method 100 proceeds to block 110.

Referring to FIG. 4B, a schematic diagram of the traffic sign 60 with a second segmentation mask 70b is shown. With reference to FIG. 4B and continued reference to FIG. 3, at block 110, the vehicle controller 14 identifies a plurality of edges 74 of the traffic sign 60 and generates a second segmentation mask 70b. In an exemplary embodiment, a first terminus and a second terminus of each of the plurality of edges 74 is one of the four points 72. Therefore, the plurality of edges 74 form a closed polygon. In an exemplary embodiment, the plurality of edges 74 of the traffic sign 60 are identified using a machine learning algorithm (e.g., a CNN) trained to identify the plurality of edges 74 based on the points 72. In another exemplary embodiment, the plurality of edges 74 of the traffic sign 60 are identified using an iterative algorithm. It should be understood that various additional methods for identifying the plurality of edges 74 are within the scope of the present disclosure.

In an exemplary embodiment, the plurality of edges 74 form a closed polygon which is the second segmentation mask 70b. In other words, the second segmentation mask 70b is an area of the image enclosed by the plurality of edges 74. In the scope of the present disclosure, the second segmentation mask 70b is an optimized version (i.e., a regularly shaped, noise-reduced version) of the first segmentation mask 70a based on the plurality of points 72 and an assumption that the detected object is a traffic sign and that a shape of the traffic sign 60 may be accurately represented by connecting each of the plurality of points 72 with a straight line (i.e., one of the plurality of edges 74) to form a closed polygon (i.e., the second segmentation mask 70b). After block 110, the method 100 proceeds to blocks 112 and 114.

Referring to FIG. 4C, a schematic diagram of an intersection area 76 between the first segmentation mask 70a and the second segmentation mask 70b is shown. With reference to FIG. 4C and continued reference to FIG. 3, at block 112, the vehicle controller 14 determines the intersection area 76 between the first segmentation mask 70a and the second segmentation mask 70b. In the scope of the present disclosure, the intersection area 76 is a region of overlap between the first segmentation mask 70a and the second segmentation mask 70b when the first segmentation mask 70a is overlayed on the second segmentation mask 70b. In an exemplary embodiment, the intersection area 76 is determined based on the x and y-coordinates of the first segmentation mask 70a and the second segmentation mask 70b. Mathematically, the intersection area 76 is represented as:

$${I}_{A} = {M}_{1} ⋂ {M}_{2} \qquad ( 1 )$$

wherein I_{A} is the intersection area 76, M₁ is the first segmentation mask 70a, and M₂ is the second segmentation mask 70b. After block 112, the method 100 proceeds to block 116, as will be discussed in greater detail below.

Referring to FIG. 4D, a schematic diagram of a union area 78 between the first segmentation mask 70a and the second segmentation mask 70b is shown. With reference to FIG. 4D and continued reference to FIG. 3, at block 114, the vehicle controller 14 determines the union area 78 between the first segmentation mask 70a and the second segmentation mask 70b. In the scope of the present disclosure, the union area 78 is a total area covered by the first segmentation mask 70a and the second segmentation mask 70b when the first segmentation mask 70a is overlayed on the second segmentation mask 70b. In an exemplary embodiment, the union area 78 is determined based on the x and y-coordinates of the first segmentation mask 70a and the second segmentation mask 70b. Mathematically, the union area 78 is represented as:

$${U}_{A} = {M}_{1} ⋃ {M}_{2} \qquad ( 2 )$$

wherein U_{A} is the union area 78, M₁ is the first segmentation mask 70a, and M₂ is the second segmentation mask 70b. After block 114, the method 100 proceeds to block 116.

At block 116, the vehicle controller 14 determines a normalized fitness score between the first segmentation mask 70a and the second segmentation mask 70b. In the scope of the present disclosure, the normalized fitness score is a number between one and zero which quantifies the similarity between the first segmentation mask 70a and the second segmentation mask 70b. In an exemplary embodiment, the normalized fitness score is equal to the intersection area 76 as defined by Equation (1) divided by the union area 78 as defined by Equation (2), and is represented mathematically as:

$$F = \frac{{I}_{A}}{{U}_{A}} = \frac{{M}_{1} ⋂ {M}_{2}}{{M}_{1} ⋃ {M}_{2}} \qquad ( 3 )$$

wherein F is the normalized fitness score and I_{A}, U_{A}, M₁, and M₂ are described above. Equation (3) is also known as the Jaccard index or the Jaccard similarity coefficient. After block 116, the method 100 proceeds to block 118.

At block 118, the vehicle controller 14 compares the normalized fitness score determined at block 116 to a predetermined normalized fitness score threshold (e.g., 0.90). If the normalized fitness score is less than the predetermined normalized fitness score threshold, the method 100 proceeds to enter a standby state at block 120. If the normalized fitness score is greater than or equal to the predetermined normalized fitness score threshold, the method 100 proceeds to block 122.

At block 122, the vehicle controller 14 determines the pan angle 62 and the tilt angle of the traffic sign 60, as will be discussed in greater detail below. After block 122, the method 100 proceeds to block 124.

At block 124, the vehicle controller 14 determines a relevance of the traffic sign 60 based on the pan angle 62 and the tilt angle. In an exemplary embodiment, the vehicle controller 14 compares the pan angle 62 to a predetermined pan angle threshold (e.g., 45 degrees) and the tilt angle to a predetermined tilt angle threshold (e.g., 100 degrees). In some examples, the absolute values of the pan angle 62 and tilt angle are used to account for cases where a negative pan angle 62 or tilt angle is determined. If the pan angle 62 is greater than or equal to the predetermined pan angle threshold OR the tilt angle is greater than or equal to the predetermined tilt angle threshold, the traffic sign 60 is determined to be irrelevant, and the method 100 proceeds to enter the standby state at block 120. If the pan angle 62 is less than the predetermined pan angle threshold AND the tilt angle is less than the predetermined tilt angle threshold, the traffic sign 60 is determined to be relevant, and the method 100 proceeds to block 126.

At block 126, the vehicle controller 14 transmits the relevance of the traffic sign 60 determined at block 124 to the remote server system 40, as will be discussed in greater detail below. After block 126, the method 100 proceeds to enter the standby state at block 120.

In an exemplary embodiment, the vehicle controller 14 repeatedly exits the standby state 120 and restarts the method 100 at block 102. In a non-limiting example, the vehicle controller 14 exits the standby state 120 and restarts the method 100 on a timer, for example, every three hundred milliseconds.

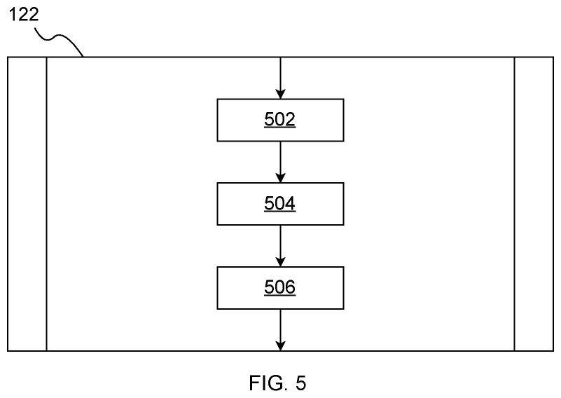

Referring to FIG. 5, a flowchart of an exemplary embodiment of block 122 is shown. The exemplary embodiment of block 122 begins at block 502. At block 502, the vehicle controller 14 identifies a first vanishing point of the traffic sign 60 in the image. In an exemplary embodiment, the first vanishing point is determined by projecting two substantially horizontal edges of the plurality of edges 74 (i.e., a top and bottom edge of the traffic sign 60) until they intersect. The point at which the projections of the two of the plurality of edges 74 intersect is the first vanishing point. Therefore, the first vanishing point is determined based at least on the plurality of edges 74 identified at block 110. After block 502, the exemplary embodiment of block 122 proceeds to block 504.

At block 504, the vehicle controller 14 identifies a second vanishing point of the traffic sign 60 in the image. In an exemplary embodiment, the second vanishing point is determined by projecting two substantially vertical edges of the plurality of edges 74 (i.e., a left and right edge of the traffic sign 60) until they intersect. The point at which the projections of the two of the plurality of edges 74 intersect is the second vanishing point. Therefore, the second vanishing point is determined based at least on the plurality of edges 74 identified at block 110. After block 504, the exemplary embodiment of block 122 proceeds to block 506.

It should be understood that various methods may be used to determine the first vanishing point and the second vanishing point at blocks 502 and 504 without departing from the scope of the present disclosure. In an exemplary embodiment, the plurality of edges 74 are extended until they intersect to identify the vanishing points. In another exemplary embodiment, a machine learning algorithm (e.g., a CNN) trained to identify vanishing points is used. In yet another exemplary embodiment, computational methods are used, such as those disclosed in MAGEE, M., et al. “Determining vanishing points from perspective images.” Computer Vision, Graphics, and Image Processing, vol. 26, 1984, pages 256-267, the entire contents of which is hereby incorporated by reference.

At block 506, the vehicle controller 14 determines the pan angle 62 and the tilt angle of the traffic sign 60 based on the first vanishing point determined at block 502 and the second vanishing point determined at block 504. In an exemplary embodiment, the coordinates of the first vanishing point and the second vanishing point are first translated to camera coordinates using a camera calibration matrix (often referred to as K). In the scope of the present disclosure, the camera calibration matrix K encodes intrinsic properties of the vehicle camera 22 determined by the lens and sensor configuration of the vehicle camera 22. In a non-limiting example, the camera calibration matrix K is predetermined and stored in the media 20 of the vehicle controller 14. Subsequently, a rotation matrix (often referred to as R) is determined:

$$R = [ \begin{matrix}{r}_{1} & {r}_{2} & {r}_{3}\end{matrix} ] = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \qquad ( 4 )$$

wherein R is the rotation matrix, n is a first column of the rotation matrix, r₂ is a second column of the rotation matrix, and r₃ is a third column of the rotation matrix. The columns of the rotation matrix are determined based on the camera coordinates of the first and second vanishing points:

$${r}_{1} = \frac{{V}_{1}}{‖ {V}_{1} ‖} \qquad ( 5 )$$

$${r}_{2} = \frac{{V}_{2}}{‖ {V}_{2} ‖} \qquad ( 6 )$$

$${r}_{3} = {r}_{1} \times {r}_{2} \qquad ( 7 )$$

wherein V₁ is the camera coordinate of the first vanishing point, and V₂ is the camera coordinate of the second vanishing point. The pan angle 62 and tilt angle of the traffic sign 60 are determined based on the rotation matrix R:

$${θ}_{p} = {tan}^{- 1} ( {r}_{32} , {r}_{33} ) \qquad ( 8 )$$

$${θ}_{t} = {tan}^{- 1} ( - {r}_{31} , \sqrt{{r}_{32}^{2} + {r}_{33}^{2}} ) \qquad ( 9 )$$

wherein θₚ is the pan angle 62 and θₜ is the tilt angle.

It should be understood that various additional methods may be used to determine the pan angle 62 and the tilt angle without departing from the scope of the present disclosure. For example, the method disclosed in CIPOLLA, R., et al. “PhotoBuilder-3D models of architectural scenes from uncalibrated images,” IEEE International Conference on Multimedia Computing and Systems, Vol. 1, 1999, pages 25-31, the entire contents of which is hereby incorporated by reference, may be used to determine the pan angle 62 and the tilt angle without departing from the scope of the present disclosure. After block 506, the exemplary embodiment of block 122 is concluded, and the method 100 proceeds as discussed above.

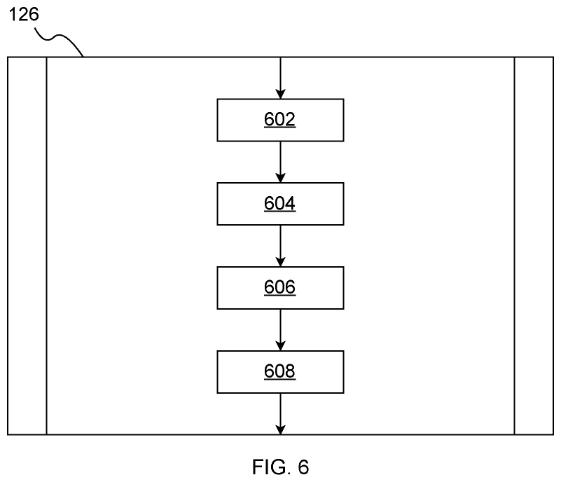

Referring to FIG. 6, a flowchart of an exemplary embodiment of block 126 is shown. The exemplary embodiment of block 126 begins at block 602. At block 602, the vehicle controller 14 determines a location of the vehicle 12 using the GNSS 24. After block 602, the exemplary embodiment of block 126 proceeds to block 604. At block 604, the vehicle controller 14 determines a location of the traffic sign 60. In an exemplary embodiment, the location of the traffic sign 60 is determined based at least in part on the location of the vehicle 12 determined at block 602. In a non-limiting example, a distance between the traffic sign 60 and the vehicle 12 is estimated based on the image captured at block 104 and a computer vision algorithm. In another non-limiting example, an additional vehicle perception sensor, such as a LIDAR sensor, is used to measure the distance between the traffic sign 60 and the vehicle 12. After block 604, the exemplary embodiment of block 126 proceeds to block 606.

At block 606, the vehicle controller 14 saves the relevance of the traffic sign 60 determined at block 124 and the location of the traffic sign 60 determined at block 604 in the media 20 of the vehicle controller 14. After block 606, the exemplary embodiment of block 126 proceeds to block 608.

At block 608, the vehicle controller 14 transmits the relevance of the traffic sign 60 and the location of the traffic sign 60 saved in the media 20 of the vehicle controller 14 at block 604 to the remote server system 40 using the vehicle communication system 26. It should be understood that in some embodiments, additional information about the traffic sign 60, such as, for example, traffic sign meaning or content, may also be transmitted to the remote server system 40. In an exemplary embodiment, the server communication system 46 receives the transmission from the vehicle communication system 26 and the server controller 42 saves the relevance of the traffic sign 60 and the location of the traffic sign 60 in the server database 44. After gathering location and relevance information of traffic signs in the server database 44, the remote server system 40 may transmit location and relevance information of traffic signs to additional remote vehicles or systems. After gathering location and relevance information of traffic signs in the server database 44, the remote server system 40 may also update map information stored in the server database 44 based on the relevance of the traffic sign 60 and the location of the traffic sign 60. After block 608, the exemplary embodiment of block 126 is concluded, and the method 100 proceeds as discussed above.

The system 10 and method 100 of the present disclosure offer several advantages. Using the system 10, the method 100 enables identification and determination of traffic sign relevance based on orientation (i.e., pan angle and tilt angle) of the traffic sign relative to the vehicle. To identify the relevance of a traffic sign, the method 100 requires only the vehicle camera 22 and no additional sensor systems, reducing complexity and resource use. After identifying relevance of a traffic sign, the method 100 allows for transmission of relevance information to a remote server system 40, thus enabling cloud-sourced data gathering of traffic sign location and relevance. Furthermore, traffic sign relevance information may be used to provide information to an occupant of the vehicle 12 (e.g., using a human-machine interface) or affect the operation of driver assistance systems and/or automated driving systems to increase occupant awareness and convenience. In a non-limiting example wherein the vehicle 12 is an autonomous vehicle, the vehicle controller 14 determines whether action should be taken in response to the traffic sign 60 based on the relevance of the traffic sign 60. For example, if the traffic sign 60 is a stop sign, and the relevance of the traffic sign 60 is determined to be irrelevant, then the vehicle 12 will not stop at the traffic sign 60.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for determining a relevance of a traffic sign for a vehicle, the system comprising:
at least one vehicle camera configured to provide a view of an environment surrounding the vehicle; and
a vehicle controller in electrical communication with the at least one vehicle camera, wherein the vehicle controller is programmed to:
capture an image using the at least one vehicle camera;
identify the traffic sign in the image;
determine a pan angle and a tilt angle of the traffic sign based at least in part on the image; and
determine the relevance of the traffic sign based at least in part on the pan angle and the tilt angle of the traffic sign.

2. The system of claim 1, wherein to identify the traffic sign in the image, the vehicle controller is further programmed to:
identify an object in the image;
identify a plurality of edges of the object based at least in part on the image; and
determine the object to be the traffic sign based at least in part on the plurality of edges of the object.

3. The system of claim 2, wherein to identify the object in the image, the vehicle controller is further programmed to:
extract a region of interest of the image using a deep learning model, wherein the region of interest includes the object; and
generate a first segmentation mask of the region of interest, wherein the first segmentation mask includes a portion of the region of interest having the object.

4. The system of claim 3, wherein to identify the plurality of edges of the object, the vehicle controller is further programmed to:
determine four points which correspond to four corners of the first segmentation mask;
identify the plurality of edges of the object, wherein a first terminus and a second terminus of each of the plurality of edges is one of the four points, and wherein the plurality of edges form a closed polygon; and
generate a second segmentation mask, wherein the second segmentation mask is an area enclosed by the plurality of edges.

5. The system of claim 4, wherein to determine the object to be the traffic sign, the vehicle controller is further programmed to:
determine a normalized fitness score of the second segmentation mask with respect to the first segmentation mask;
compare the normalized fitness score to a predetermined normalized fitness score threshold; and
determine the object to be the traffic sign in response to determining that the normalized fitness score is greater than or equal to the predetermined normalized fitness score threshold.

6. The system of claim 5, wherein to determine the normalized fitness score, the vehicle controller is further programmed to:
determine an intersection area between the first segmentation mask and the second segmentation mask;
determine a union area between the first segmentation mask and the second segmentation mask; and
determine the normalized fitness score, wherein the normalized fitness score is equal to the intersection area divided by the union area.

7. The system of claim 4, wherein to determine the pan angle and the tilt angle of the traffic sign, the vehicle controller is further programmed to:
identify a first vanishing point of the traffic sign based at least in part on the plurality of edges;
identify a second vanishing point of the traffic sign based at least in part on the plurality of edges; and
determine the pan angle and the tilt angle of the traffic sign based at least in part on the first vanishing point and the second vanishing point.

8. The system of claim 1, wherein to determine the relevance of the traffic sign, the vehicle controller is further programmed to:
compare the pan angle of the traffic sign to a predetermined pan angle threshold;
compare the tilt angle of the traffic sign to a predetermined tilt angle threshold;
determine the relevance of the traffic sign to be irrelevant in response to determining that at least one of: the pan angle of the traffic sign is greater than or equal to the predetermined pan angle threshold and the tilt angle of the traffic sign is greater than or equal to the predetermined tilt angle threshold; and
determine the relevance of the traffic sign to be relevant in response to determining that: the pan angle of the traffic sign is less than the predetermined pan angle threshold and the tilt angle of the traffic sign is less than the predetermined tilt angle threshold.

9. The system of claim 1, further comprising a global navigation satellite system (GNSS) in electrical communication with the vehicle controller, wherein the vehicle controller is further programmed to:
determine a location of the vehicle using the GNSS;
determine a location of the traffic sign based at least in part on the location of the vehicle; and
save the relevance of the traffic sign and the location of the traffic sign in a non-transitory memory of the vehicle controller in response to determining that the traffic sign is relevant.

10. The system of claim 9, further comprising a vehicle communication system in electrical communication with the vehicle controller, wherein the vehicle controller is further programmed to:
transmit the relevance of the traffic sign and the location of the traffic sign to a remote server system using the vehicle communication system.

11. A method for determining a relevance of a traffic sign for a vehicle, the method comprising:
capturing an image using at least one vehicle camera;
identifying the traffic sign in the image;
determining a pan angle and a tilt angle of the traffic sign based at least in part on the image; and
determining the relevance of the traffic sign based at least in part on the pan angle and the tilt angle of the traffic sign.

12. The method of claim 11, wherein identifying the traffic sign in the image further comprises:
identifying an object in the image;
identifying a plurality of edges of the object based at least in part on the image; and
determining the object to be the traffic sign based at least in part on the plurality of edges of the object.

13. The method of claim 12, wherein identifying the object in the image further comprises:
extracting a region of interest of the image using a deep learning model, wherein the region of interest includes the object; and
generating a first segmentation mask of the region of interest, wherein the first segmentation mask includes a portion of the region of interest having the object.

14. The method of claim 13, wherein identifying the plurality of edges of the object further comprises:
determining four points which correspond to four corners of the first segmentation mask;
identifying the plurality of edges of the object, wherein a first terminus and a second terminus of each of the plurality of edges is one of the four points, and wherein the plurality of edges form a closed polygon; and
generating a second segmentation mask, wherein the second segmentation mask is an area enclosed by the plurality of edges.

15. The method of claim 14, wherein determining the object to be the traffic sign further comprises:
determining an intersection area between the first segmentation mask and the second segmentation mask;
determining a union area between the first segmentation mask and the second segmentation mask;
determining a normalized fitness score, wherein the normalized fitness score is equal to the intersection area divided by the union area;
comparing the normalized fitness score to a predetermined normalized fitness score threshold; and
determining the object to be the traffic sign in response to determining that the normalized fitness score is greater than or equal to the predetermined normalized fitness score threshold.

16. The method of claim 14, wherein determining the pan angle and the tilt angle of the traffic sign further comprises:
identifying a first vanishing point of the traffic sign based at least in part on the plurality of edges;
identifying a second vanishing point of the traffic sign based at least in part on the plurality of edges; and
determining the pan angle and the tilt angle of the traffic sign based at least in part on the first vanishing point and the second vanishing point.

17. The method of claim 11, wherein determining the relevance of the traffic sign further comprises:
comparing the pan angle of the traffic sign to a predetermined pan angle threshold;
comparing the tilt angle of the traffic sign to a predetermined tilt angle threshold;
determining the relevance of the traffic sign to be irrelevant in response to determining that at least one of: the pan angle of the traffic sign is greater than or equal to the predetermined pan angle threshold and the tilt angle of the traffic sign is greater than or equal to the predetermined tilt angle threshold; and
determining the relevance of the traffic sign to be relevant in response to determining that: the pan angle of the traffic sign is less than the predetermined pan angle threshold and the tilt angle of the traffic sign is less than the predetermined tilt angle threshold.

18. A system for determining a relevance of a traffic sign for a vehicle, the system comprising:
at least one vehicle camera configured to provide a view of an environment surrounding the vehicle; and
a vehicle controller in electrical communication with the at least one vehicle camera, wherein the vehicle controller is programmed to:
capture an image using the at least one vehicle camera;
extract a region of interest of the image using a deep learning model, wherein the region of interest includes an object;
generate a first segmentation mask of the region of interest, wherein the first segmentation mask describes a portion of the region of interest including only the object;
determine four points which correspond to four corners of the first segmentation mask;
identify a plurality of edges of the object, wherein a first terminus and a second terminus of each of the plurality of edges is one of the four points, and wherein the plurality of edges form a closed polygon;
generate a second segmentation mask, wherein the second segmentation mask is an area enclosed by the plurality of edges.
determine the object to be the traffic sign based at least in part on the plurality of edges of the object;
determine a pan angle and a tilt angle of the traffic sign based at least in part on the image;
compare the pan angle of the traffic sign to a predetermined pan angle threshold;
compare the tilt angle of the traffic sign to a predetermined tilt angle threshold;
determine the relevance of the traffic sign to be irrelevant in response to determining that at least one of: the pan angle of the traffic sign is greater than or equal to the predetermined pan angle threshold and the tilt angle of the traffic sign is greater than or equal to the predetermined tilt angle threshold; and
determine the relevance of the traffic sign to be relevant in response to determining that: the pan angle of the traffic sign is less than the predetermined pan angle threshold and the tilt angle of the traffic sign is less than the predetermined tilt angle threshold.

19. The system of claim 18, wherein to determine the object to be the traffic sign, the vehicle controller is further programmed to:
determine an intersection area between the first segmentation mask and the second segmentation mask;
determine a union area between the first segmentation mask and the second segmentation mask;
determine a normalized fitness score, wherein the normalized fitness score is equal to the intersection area divided by the union area;
compare the normalized fitness score to a predetermined normalized fitness score threshold; and
determine the object to be the traffic sign in response to determining that the normalized fitness score is greater than or equal to the predetermined normalized fitness score threshold.

20. The system of claim 19, wherein to determine the pan angle and the tilt angle of the traffic sign, the vehicle controller is further programmed to:
identify a first vanishing point of the traffic sign based at least in part on the plurality of edges;
identify a second vanishing point of the traffic sign based at least in part on the plurality of edges; and
determine the pan angle and the tilt angle of the traffic sign based at least in part on the first vanishing point and the second vanishing point.
